(19) United States
(12) Patent Application Publication
(10) Pub. No.: US 2019/0053640 A1
(43) Pub. Date: Feb. 21, 2019

(54) SHOWCASE AND METHOD OF DRIVING THE SAME

(71) Applicant: Migang Display Co., Ltd, Seongnam-si (KR)

(72) Inventor: Sun Ki MIN, Seoul (KR)

(73) Assignee: Migang Display Co., Ltd, Seongnam-si (KR)

(21) Appl. No.: 15/681,437

(22) Filed: Aug. 21, 2017

(51) Int. Cl. A47F 3/00; A47F 11/10; G09G 3/34

(52) U.S. Cl. CPC A47F 3/001; A47F 3/005; G09G 2320/0646; G09G 3/34; G09G 2370/022; A47F 11/10

(57) ABSTRACT

The present invention is directed to a showcase which can display two-dimensional recoding, such as a photo or moving image, and three-dimensional recording, such as figures kept in the showcase, in harmony and a method of driving the same and that includes: a lower plate having a square plate form and having a control board disposed therein; a transparent display panel configured to stand up at the front over the lower plate; a pair of transparent members configured to stand up on two facing sides over the lower plate; a back cover configured to be open or shut at the back over the lower plate; and an upper plate configured to face the lower plate, to cover an internal space confined by the transparent display panel, the pair of transparent members and the back cover and to have a lighting device electrically connected to the control board.

### BACKGROUND OF THE INVENTION

### 1. Technical Field

Embodiments of the present invention relate to a showcase and, more particularly, to a showcase which can display two-dimensional recoding, such as a photo or moving image, and three-dimensional recording, such as figures kept in the showcase, in harmony and a method of driving the same.

### 2. Description of the Related Art

In general, a showcase is used to exhibit a product. A conventional showcase simply holds a product on its display stand and enables the product to be protected and viewed through a transparent glass window. Furthermore, a light is disposed within the showcase to illustrate a product so that the product can be well viewed.

Recently, with the development of a material technology, transparent displays, such as a liquid crystal display (LCD) and active matrix organic light emitting diode (AMOLED), have been developed and commercialized. In addition, transparent displays are developed in various display forms.

An advantage of the transparent display is that any information can be displayed in a screen form and a thing or background located in the back of the transparent display can also be penetrated and viewed. It is expected that such a transparent display will be used in various industry fields, such as the window of a fighter airplane, a vehicle window and a door-type TV.

However, a technology in which such a transparent display has been applied to the showcase of a product has not been commercialized. Product sellers only stimulate consumers' purchase needs using lights by taking products into consideration. Furthermore, a system for providing a screen matched with a product through a transparent display by frequently replacing a screen displayed on the transparent display in association with the product has not yet been developed.

### SUMMARY OF THE INVENTION

Accordingly, the present invention has been made keeping in mind the above problems occurring in the prior art, and an object of the present invention is to provide a showcase, which allows figures or articles in custody within the showcase to be seen from the outside by applying a transparent display to the front of the showcase and applying transparent members on both sides of the showcase and can also selectively display a photo or image along with figures or articles in custody in front of the showcase when a transparent display panel is driven, and a method of driving the same.

Another object of the present invention is to provide a method of driving a showcase, which is capable of performing control so that figures or articles in custody within a showcase are visible or invisible depending on lighting within the showcase.

An aspect of the present invention provides a showcase, including a lower plate having a square plate form and having a control board disposed therein; a transparent display panel configured to stand up at the front over the lower plate; a pair of transparent members configured to stand up on two facing sides over the lower plate; a back cover configured to be open or shut at the back over the lower plate; and an upper plate configured to face the lower plate, to cover an internal space confined by the transparent display panel, the pair of transparent members and the back cover and to have a lighting device electrically connected to a control board disposed therein.

In one embodiment, the control board may operate to turn on the lighting device in response to an operation signal of the transparent display panel, calculate an average intensity of illumination of an image displayed on the transparent display panel, calculate a difference between the calculated average intensity of illumination and a reference value, and control intensity of illumination of the lighting device based on the difference.

In one embodiment, the transparent member may restrict the exposure of the inside of the showcase by reflecting an external visible ray directed toward an internal accommodation space when the lighting device is turned on.

In one embodiment, the control board may control the operation of the transparent display panel or the lighting device in response to a command received through a communication module from a user at a remote place.

In one embodiment, the showcase may further include a touch screen disposed on the transparent display panel.

In one embodiment, the showcase may further include a speaker disposed in the upper plate or the lower plate. The upper plate or the lower plate includes a plurality of through holes for generating a sound and emitting heat on the side thereof.

Another aspect of the present invention provides a method of driving a showcase, including driving a lighting device within a showcase in response to the operation start signal of a transparent display panel; displaying an image on the transparent display panel; comparing an average brightness value of a screen on which the image is displayed with a reference value; and controlling brightness of a lighting device based on a difference between the calculated average brightness value of the screen and the reference value.

### BRIEF DESCRIPTION OF THE DRAWINGS

FIG. 1 is a perspective view of a showcase according to an embodiment of the present invention.

FIG. 2 is a left side view of the showcase of FIG. 1.

FIG. 3 is an exploded perspective view of the showcase of FIG. 1.

FIG. 4 is a front view of a showcase according to another embodiment of the present invention.

FIG. 5 is a plan view of the showcase of FIG. 4.

FIG. 6 is a right side view of the showcase of FIG. 4.

FIG. 7 is a cross-sectional view of a transparent member which may be adopted in the showcase according to the present embodiment.

FIG. 8 is a block diagram of an electrical part which may be mounted on the showcase according to the present embodiment.

FIG. 9 is a flowchart illustrating a method of driving the showcase according to another embodiment of the present invention.

FIG. 10 shows the system configuration of a showcase implementation system for illustrating a showcase according to another embodiment of the present invention a method of driving the same.

### DETAILED DESCRIPTION

Hereinafter, forms of the present disclosure will be described in detail with reference to the accompanying drawings. As those skilled in the art would realize, the described forms may be modified in various different ways, all without departing from the spirit or scope of the present disclosure. Further, throughout the specification, like reference numerals refer to like elements.

The terminology used herein is for the purpose of describing particular forms only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although forms are described herein as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules, and the processor is specifically configured to execute said modules to perform one or more processes which are described further below. Moreover, it is understood that the units or modules described herein may embody a controller/control unit for controlling operation of the unit or module.

Further, control logic of the present disclosure may be embodied as non-transitory computer readable media on a computer readable medium containing executable program instructions executed by a processor, controller/control unit or the like.

Relational terms such as first, second, and the like may be used for describing various elements, but the elements should not be limited by the terms. These terms are only used to distinguish one element from another. For example, a first component may be named a second component without being departed from the scope of the present disclosure and the second component may also be similarly named the first component. The term ‘and/or’ means any one or a combination of a plurality of related and described items.

When it is mentioned that a certain component is “coupled with” or “connected with” another component, it should be understood that the certain component is directly “coupled with” or “connected with” to the other component or a further component may be located therebetween. In contrast, when it is mentioned that a certain component is “directly coupled with” or “directly connected with” another component, it will be understood that a further component is not located therebetween.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

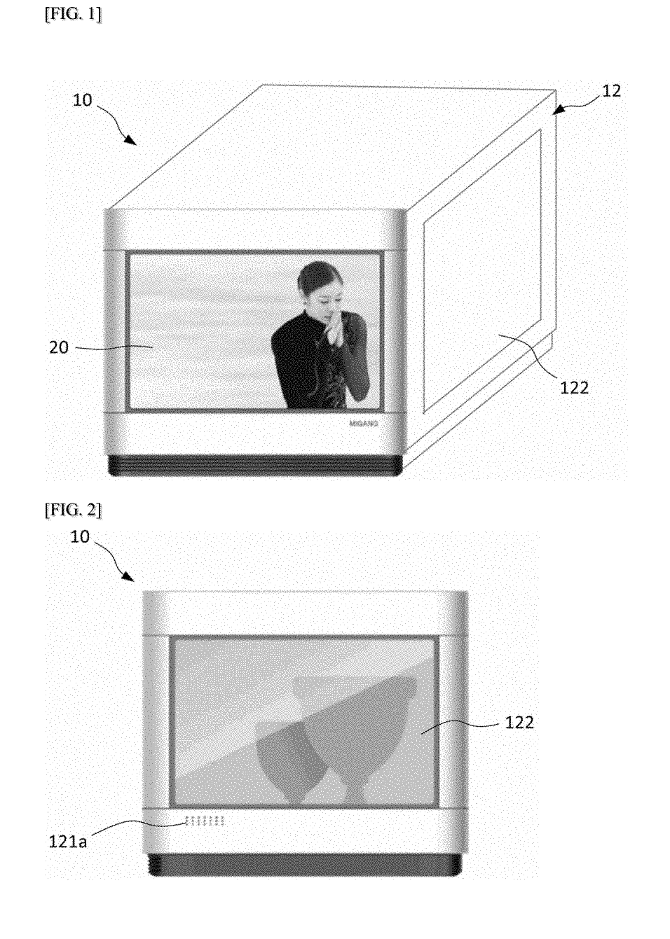

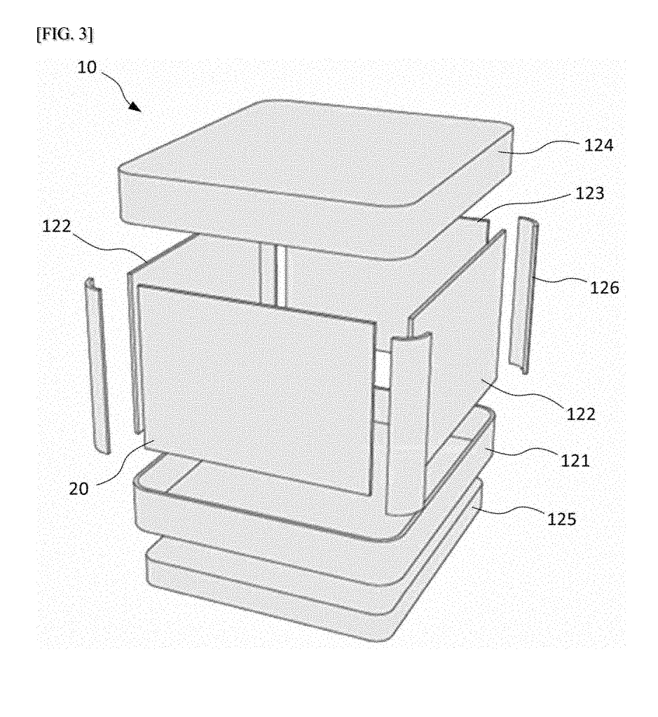

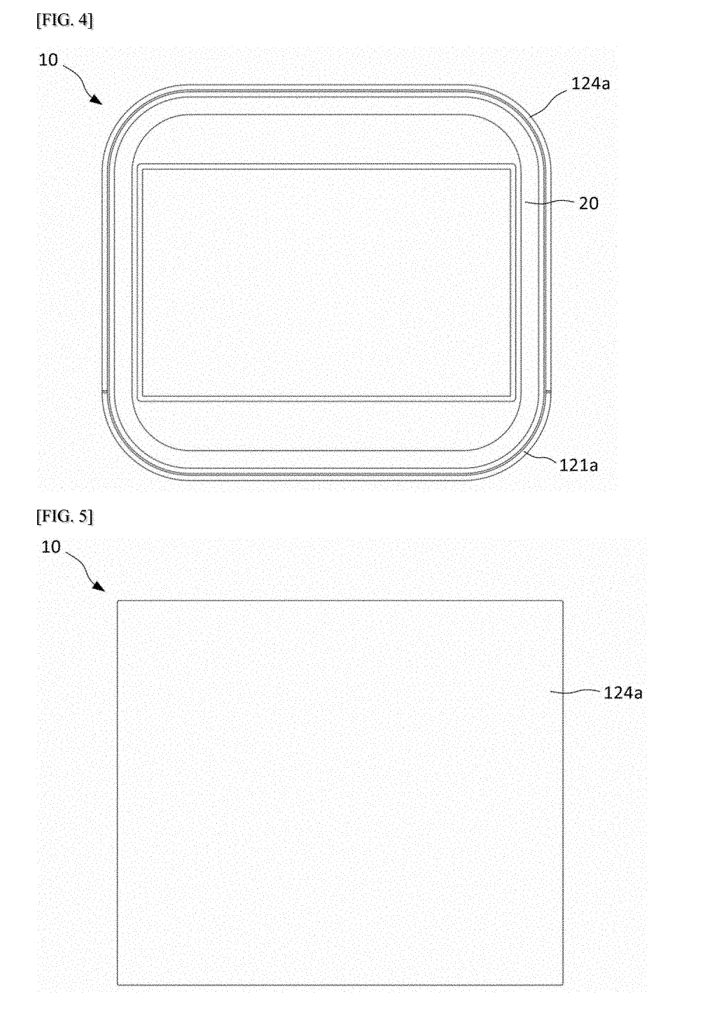

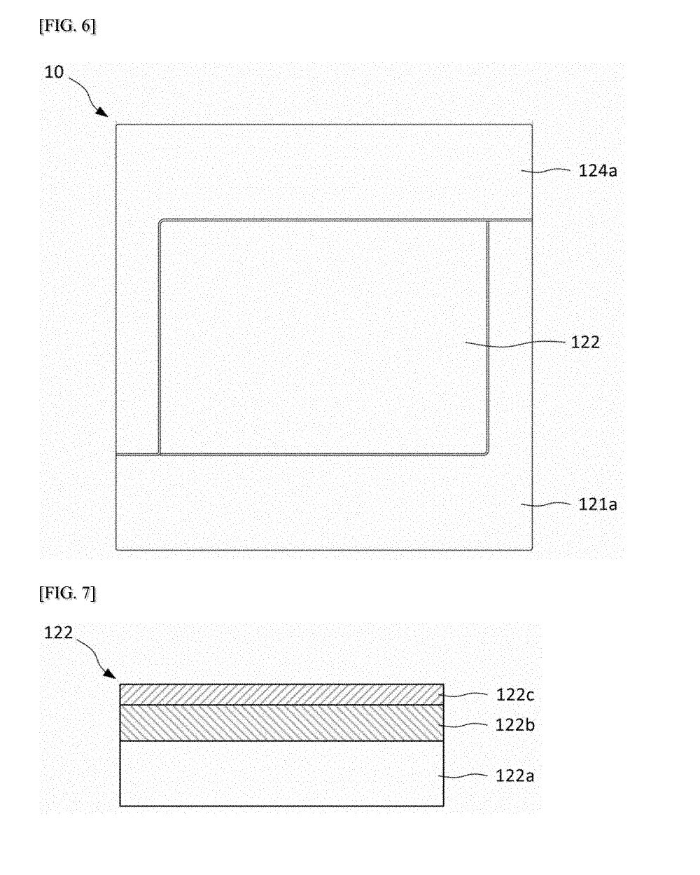

FIG. 1 is a perspective view of a showcase according to an embodiment of the present invention. FIG. 2 is a left side view of the showcase of FIG. 1. FIG. 3 is an exploded perspective view of the showcase of FIG. 1. FIG. 4 is a front view of a showcase according to another embodiment of the present invention. FIG. 5 is a plan view of the showcase of FIG. 4. FIG. 6 is a right side view of the showcase of FIG. 4. FIG. 7 is a cross-sectional view of a transparent member which may be adopted in the showcase according to the present embodiment.

Referring to FIGS. 1 to 3 and 7, a showcase 10 according to the present embodiment may be configured to include a body 12 of a box form, a transparent display panel 20, a control board and a lighting device.

The showcase 10 has transparent glass member formed in the front and on the left and right sides thereof so that the internal space part of the showcase is seen through. Accordingly, figures or a product disposed within the showcase can be exposed, and an image related to figures and a product can also be played back through the display panel 20.

In this case, the showcase 10 provides lighting through a lighting device and controls internal lighting brightness depending on the brightness of an image output by the display panel 20, thereby increasing the degree of matching between articles in custody and an image. Accordingly, a person who watches an image can view a comfortable image.

The display panel 20 is disposed in the front surface of the body 12. The body 12 includes a lower plate 121 configured to have a square plate form and have a control board disposed therein, a pair of transparent members 122 configured to stand up on two facing sides over the lower plate 121, a back cover 123 disposed to be open or shut at the back over the lower plate 121, and an upper plate 124 configured to face the lower plate 121, cover the internal space confined by the display panel 20, the pair of transparent members 122 and the back cover 123 and have the lighting device electrically connected to the control board disposed in the upper plate 124.

The pair of transparent members 122 forming sidewalls enables figures or a product within the body 12 to be visible to the naked eye through the left and right surfaces. The transparent member 122 is configured to have a transparent base material 122a, a light diffusion layer 122b and a protection layer 122c sequentially stacked thereon and thus switches from a substantially opaque state to a substantially transparent state by internal lighting.

The transparent base material 122a restricts the exposure of the inside of the showcase by reflecting an external visible ray directed toward the internal accommodation space when the lighting device is turned on. The material of the transparent base material 122a is not specially limited if it has optical transparency. For example, resin, such as polyesters resin (e.g., polyethylene terephthalate or polyethylenenaphthenate), polycarbonates resin, polyacrylic acid polyester-based resin (e.g., polymethyl methacrylate), alicyclic polyolefin-based resin, polystyrene-based resin (e.g., polystyrene or acrylonitrile styrene copolymer (AS resin)), polyvinyl chloride resin, polyacetic acid vinylic resin, polyethersulfone-based resin, cellulose-based resin (e.g., Diacetyl cellulose, cellulose triacetate) or norbornenes resin, may be processed in a film form or sheet form and used as the transparent base material 122a.

The light diffusion layer 122b is disposed on the top surface of the transparent base material 122a and has a layer in which light diffusion particles dispersed in the transparent resin. Furthermore, the material of the light diffusion layer 122b is not specially limited if it has optical transparency. Known resin, such as thermoplastic resin, thermosetting resin or ionizing radiation-curable resin; for example, (meta)acrylic resin, acrylurethane-based resin, polyesters resin, polyester acrylates resin, polyurethane(meta)acrylates resin, epoxy(meta)acrylates resin, polyurethane-based resin, epoxy-based resin, polycarbonates resin, cellulose-based resin, acetal-based resin, vinylic resin, polyethylene-based resin, polystyrene-based resin, polypropylene-based resin, ethylene acetic acid vinylic resin, polyamide-based resin, polyimides resin, melamine-based resin, phenolicresin, silicon-based resin or fluoro-based resin, or rubber-based resin, such as natural rubber-based resin, reclaimed rubber-based, chloroprene rubber-based, nitrile rubber-based or styrene butadiene rubber, an adhesive or a glue may be used as the light diffusion layer 122b.

The protection layer 122c is disposed on the top surface of the light diffusion layer 122b and may have a protection layer, including ionizing radiation-curable resin or thermosetting resin, formed on a surface (on the air side) thereof as a hard coating layer. The protection layer 122c may be made of transparent ionizing radiation-curable resin, including at least ionizing radiation-curable resin monomer, ionizing radiation-curable resin oligomer or a mixture thereof. The protection layer made of the ionizing radiation-curable resin may be cured and formed by radiating using ionizing radiation.

The protection layer 122c may be omitted, if necessary, or may be replaced with another transparent base material.

The display panel 20 is a display device disposed to cover the open front of the body 12 so that a thing disposed within the body 12 of the showcase is seen through. The display panel 20 can output image content to the peripheries of a region in which a thing disposed within the showcase is seen through. For example, the transparent display panel 20 may be a transmissive LCD or a transparent AMOLED or may be replaced with another display device through which an object at the back is visible while displaying text or graphics on a screen.

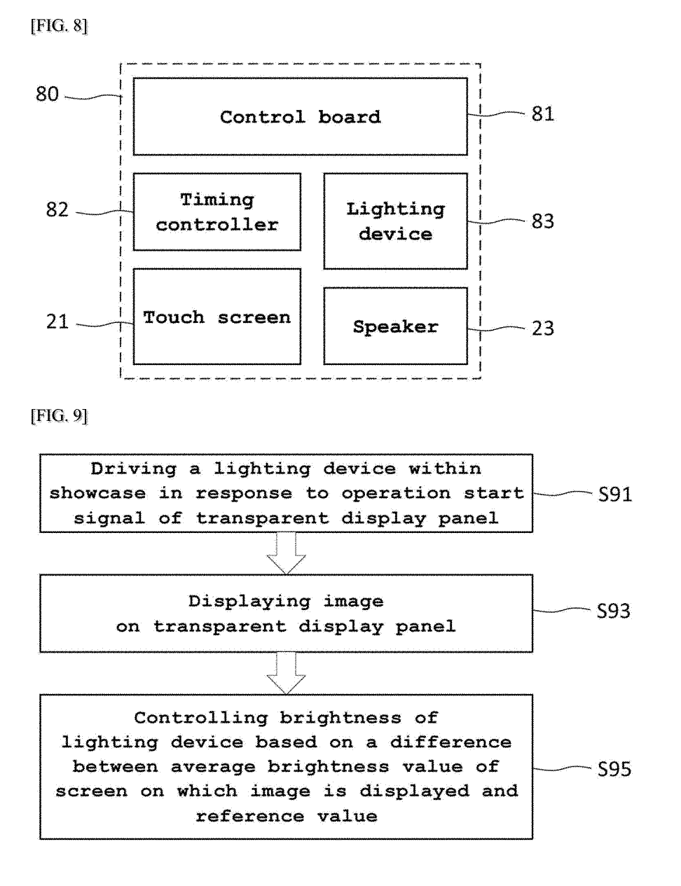

The control board (refer to 81 of FIG. 8) is disposed within the lower plate 121 and is electrically connected to the lighting device (refer to 83 of FIG. 8), thus controlling the lighting device. The display panel 20 is connected to the control circuit of the control board, and the control board may include a communication module for supporting a network.

The lighting device is disposed in the upper plate and may provide lighting to the internal space of the body 12.

Referring to FIGS. 4 to 6, the showcase 10 according to the present embodiment may include a lower plate 121a, an upper plate 124a and a display panel 20.

The lower plate 121a may have a structure which accommodates the control board and has some side casings integrated therewith. Likewise, the upper plate 124a may have a structure which accommodates the lighting device and has some side casings (refer to 126 of FIG. 3) integrated therewith. Furthermore, the lower plate 121a and the upper plate 124a may be configured to be integrally coupled with the display panel 20 at the front, the transparent members 122 on both sides and the back cover (refer to 123 of FIG. 3) interposed therebetween. In accordance with such a structure, the number of parts can be reduced and an assembly process can be simplified.

A bottom member (refer to 125 of FIG. 3) may be disposed under the lower plate 121a. The bottom member may have specific elasticity or surface roughness in order to prevent slipping when the showcase is disposed on the floor.

FIG. 8 is a block diagram of an electrical part which may be mounted on the showcase according to the present embodiment.

Referring to FIG. 8, the smart showcase according to the present embodiment may include a control board 81, a timing controller 82, a lighting device 83 and a speaker 23 disposed over and under the body 12. A touch screen 21 may be integrally disposed in the display panel.

The control board 81 controls the operation of the transparent display panel or the lighting device 83 in response to a command received through a communication module from a user at a remote place. The control board 81 supports communication over a network. Furthermore, the control board 81 may turn on the lighting device 83 in response to the operation signal of the transparent display panel, may calculate an average intensity of illumination of an image displayed on the transparent display panel, may calculate a difference between the average intensity of illumination and a reference value, and may control the intensity of illumination of the lighting device 83 based on the difference.

Furthermore, the control board 81 may be implemented in the processor and memory of a computing device implemented by the control board 81 in a hardware form, a software form or a combination form of them. The communication may include Wi-Fi.

The timing controller 82 may output data that implements an actual screen after a specific time in association with the control board 81. The timing controller controls the output of an image signal for the display panel so that an image signal received from the control board 81 is radiated to the pixels of a screen of the display panel in a predetermined manner and thus the image is displayed.

The lighting device 83 provides lighting to the internal space of the body 12. In particular, the lighting device 83 may include two light sources in order to implement the transparent state in which the inside of the showcase is invisible to the outside while the display panel 20 operates. A light using light emitting diodes (LEDs) may be used as the light source. Intensity of illumination of the light source may be about 20,000 candela (cd).

Furthermore, the speaker may be further provided on one side of the display panel, that is, in the upper plate or the lower plate, and may output content output by the display panel in a voice or sound form under control of the processor. Accordingly, the upper plate or the lower plate includes a plurality of through holes for generating a sound and emitting heat on its side.

One of the electrical parts 80 has been illustrated as being disposed in the upper plate and the other thereof has been illustrated as being disposed in the lower plate, but the present invention is not limited to such a configuration. All of the electrical parts other than the touch screen 21 may be disposed in the lower plate or the upper plate or the positions of the electrical parts may be changed.

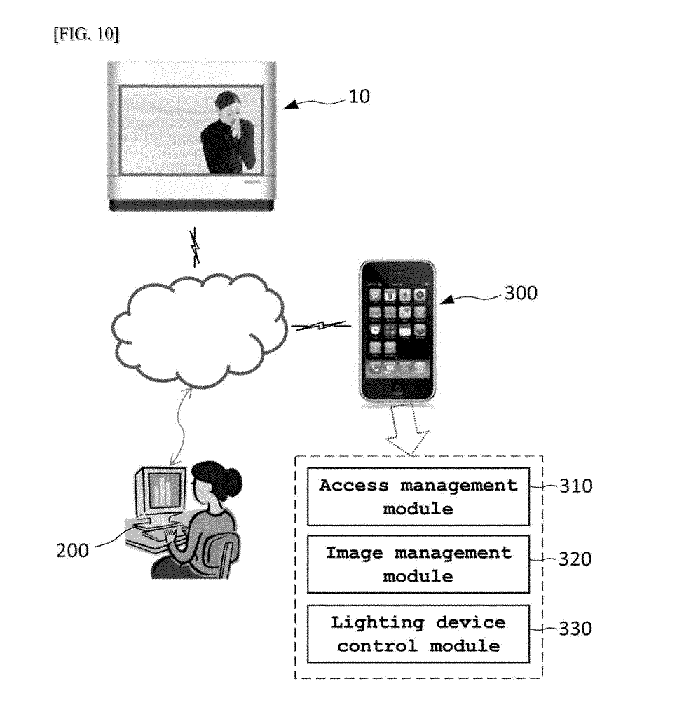

FIG. 9 is a flowchart illustrating a method of driving the showcase according to another embodiment of the present invention. FIG. 10 shows the system configuration of a showcase implementation system for illustrating a showcase according to another embodiment of the present invention a method of driving the same.

Referring to FIGS. 9 and 10, the showcase 10 according to the present embodiment is connected to a user terminal 300 and a server 200 for providing a dedicated application to the user terminal 300 over a network and is configured to receive and play back photos, moving images and documentaries including voice uploaded by a user.

A user may access the server 200 through the dedicated application connected through wired and/or wireless

Internet and may manage content stored in the smart showcase or transmit new content. The user may manage the configurations of the showcase 10 connected over a network through the user terminal 300. The user terminal 300 may include a mobile phone, a smartphone, a personal computer, etc. Furthermore, the user may access the showcase 10 through the dedicated application of the server 200 and upload playback content.

The user terminal 300 may include an access management module 310 configured to manage the access of the showcase 10 through the dedicated application, an image management module 320 configured to manage the uploading or removal of content, such as photos and moving images, and a lighting device control module 330 configured to control the lighting device of the showcase.

The showcase 10 according to the present embodiment controls the intensity of illumination of the lighting device so that image content is visible when the image content is played back through the display panel. A procedure performed by the server or the user terminal for such a service of the showcase is described below.

First, a user may access the server through the user terminal 300 and download the dedicated application. The user who has accessed the dedicated application may configure the showcase to be controlled, may upload content, such as photos, moving images and voice to be played back through the display panel of the showcase, and may control content so that the content is played back through the transparent display panel on a set time.

Accordingly, the showcase receives the operation signal of the transparent display panel through the server or the user terminal, determines whether or not to control the lighting device in response to the received signal, and drives the lighting device at step S61.

When the operation signal of the display panel is received at step S61, the showcase 10 displays an image through the transparent display panel at step S63.

An average brightness value of the image played back by the transparent display panel is compared with the reference value of screen brightness of an image previously stored in the image management module 320.

If, as a result of the comparison, the average brightness value of the image to be played back is found to be greater than or smaller than the reference value, that is, there is a difference between the average brightness value and the reference value, brightness of the lighting device is controlled at step S65. In accordance with the present embodiment, an image to be played is in harmony with (i.e., matched with) brightness or intensity of illumination within the showcase in which figures are disposed so that the internal figures can be viewed on the outside along with the image. Furthermore, in one implementation, intensity of illumination within the showcase may be made dark so that only an image on the transparent display panel is well visible.

In accordance with the aforementioned embodiments of the present invention, the transparent display device is disposed at the front so that figures, a souvenir or a product disposed within the showcase is visible to the outside and at the same time a documentary associated with articles in custody, such as figures, is implemented in a photo or image form. Accordingly, a modern and meaningful documentary storage and implementation device capable of remembering the memories of the family or inducing the purchase of a product can be promoted.

Furthermore, the present invention has an effect in that it can provide image content capable of enhancing the purchasing desire of a product in line with a time zone or seasonal zone through the showcase or a documentary can be replaced if necessary because the deletion of a documentary or the transmission of an image or message can be controlled through interoperation with a smartphone.

Furthermore, the present invention has an effect in that it can be applied to various fields, such as a souvenir box for keeping personal figures, a box for keeping companion animal figures, and a digital showcase for advertising a small-sized product such as cosmetics.

While the embodiments of the present disclosure and their advantages have been described in detail above, it should be understood that various changes, substitutions and alterations may be made herein without departing from the scope of the disclosure.

What is claimed is:

1. A showcase comprising:
a lower plate having a square plate form and having a control board disposed therein;
a transparent display panel configured to stand up at the front over the lower plate;
a pair of transparent members configured to stand up on two facing sides over the lower plate;
a back cover configured to be open or shut at the back over the lower plate; and
an upper plate configured to face the lower plate, to cover an internal space confined by the transparent display panel, the pair of transparent members and the back cover and to have a lighting device electrically connected to the control board,
wherein the control board may operate to turn on the lighting device in response to an operation signal of the transparent display panel, calculate an average intensity of illumination of an image displayed on the transparent display panel, calculate a difference between the calculated average intensity of illumination and a reference value, and control intensity of illumination of the lighting device based on the difference.

2. The showcase as claimed in claim 1, wherein the transparent member restricts the exposure of the inside of the showcase by reflecting an external visible ray directed toward an internal accommodation space when the lighting device is turned on.

3. The showcase as claimed in claim 1, wherein the control board controls the operation of the transparent display panel or the lighting device in response to a command received through a communication module from a user at a remote place.

4. The showcase as claimed in claim 1, further comprising a touch screen disposed on the transparent display panel.

5. The showcase as claimed in claim 1, further comprising a speaker disposed in the upper plate or the lower plate, wherein the upper plate or the lower plate includes a plurality of through holes for generating a sound and emitting heat on the side thereof.

6. A method of driving a showcase, comprising:
driving a lighting device within a showcase in response to the operation start signal of a transparent display panel;
displaying an image on the transparent display panel;
comparing an average brightness value of a screen on which the image is displayed with a reference value; and
controlling brightness of a lighting device in the showcase based on a difference between the calculated average brightness value of the screen and the reference value.

7. The method of driving a showcase as claimed in claim 6, the controlling includes controlling brightness of the lighting device so that figures or articles in custody within the showcase are visible or invisible depending on lighting within the showcase.
